(19) United States
(12) Patent Application Publication
(10) Pub. No.: US 2010/0053949 A1
(43) Pub. Date: Mar. 4, 2010

(54) LED LAMP

(75) Inventors: RI-LANG YANG, Shenzhen City (CN); GUANG YU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/261,054

(22) Filed: Oct. 30, 2008

(30) Foreign Application Priority Data
Aug. 27, 2008 (CN) 200810304234.X

(51) Int. Cl. F21V 29/00

(52) U.S. Cl. 362/234

(57) ABSTRACT

An LED lamp includes a heat sink, a first and second LED modules mounted on the heat sink, a reflector and a supporting post connecting the heat sink and the reflector. The heat sink includes a base having a first end and a second end opposing to the first end, and a plurality of fins extending from the base and between the first and second ends thereof. The first and second LED modules are mounted on the first and second ends of the base, respectively. The supporting post is disposed on the second end of the base with one end thereof connecting the reflector. The reflector is facing towards the second LED module to reflect light generated therefrom toward the first LED module over an enlarged area.

### BACKGROUND OF THE INVENTION

1. Field of the Invention

The present invention relates to an LED lamp, and particularly to an LED lamp providing illumination of a large area.

2. Description of Related Art

An LED lamp is a type of solid-state lighting device that utilizes light-emitting diodes (LEDs) as a source of illumination. The LED has an advantage that it is resistant to shock, and has an almost eternal lifetime under a specific condition; thus, the LED lamp is intended to be a cost-effective yet high quality replacement for incandescent and fluorescent lamps. A commonly used LED lamp comprises a plate-shaped heat sink and an LED module mounted on one side thereof. The LED module includes a PCB and a plurality of LEDs arranged thereon in a discrete linear array. In use, light generated by the LED module directly irradiates the outside of the LED lamp. However, as the LED module is mounted on one side of the heat sink, light produced cannot evenly illuminate an area around the LED lamp, which makes the LED lamp unsuitable for use when a large area requires illumination.

What is needed, therefore, is an improved LED lamp which can overcome the described disadvantages.

### SUMMARY OF THE INVENTION

An LED lamp includes a heat sink, a first and second LED modules mounted on the heat sink, a reflector and a supporting post connecting the heat sink and the reflector. The heat sink includes a base having a first end and a second end opposing to the first end, and a plurality of fins extending from the base and between the first and second ends thereof. The first and second LED modules are mounted on the first and second ends of the base, respectively. Light generated by the first LED module irradiates to a predetermined direction. The supporting post is disposed on the second end of the base with one end thereof connecting the reflector. The reflector is facing towards the second LED module to reflect light generated therefrom towards the predetermined direction over an enlarged area, thereby increasing an illumination area and brightness of the LED lamp at the predetermined direction.

Other advantages and novel features will become more apparent from the following detailed description of preferred embodiments when taken in conjunction with the accompanying drawings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, assembled view of an LED lamp in accordance with a preferred embodiment of the present invention.

FIG. 2 is an exploded view of the LED lamp in FIG. 1.

FIG. 3 is an inverted view of the LED lamp in FIG. 2.

### DETAILED DESCRIPTION OF THE INVENTION

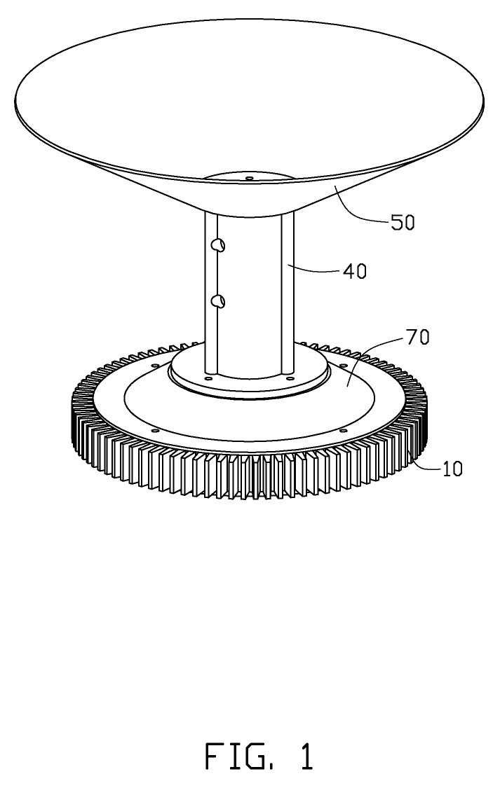

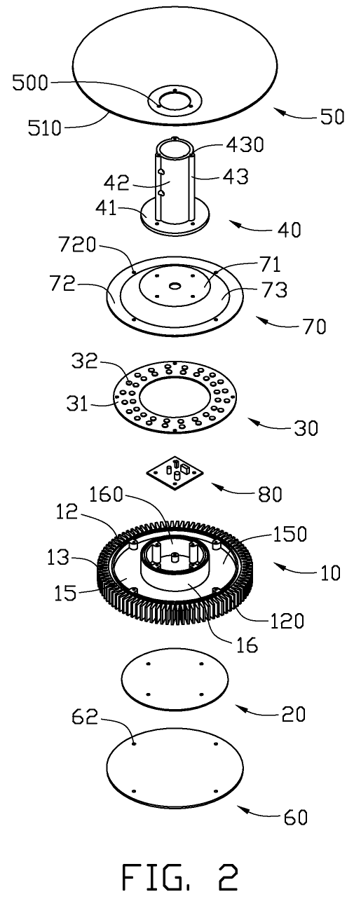

Referring to FIGS. 1-2, an LED lamp in accordance with a preferred embodiment comprises a heat sink 10, a first LED module 20 mounted on a bottom end of the heat sink 10, a second LED module 30 mounted on a top end of the heat sink 10, a supporting post 40 disposed on the top end of the heat sink 10 and a reflector 50 arranged on the supporting post 40 and apart from the second LED module 30. A bottom envelope 60 covers the first LED module 20, and a top envelope 70 covers the second LED module 30. A rectifier 80 is located below the supporting post 40 and received in the heat sink 10.

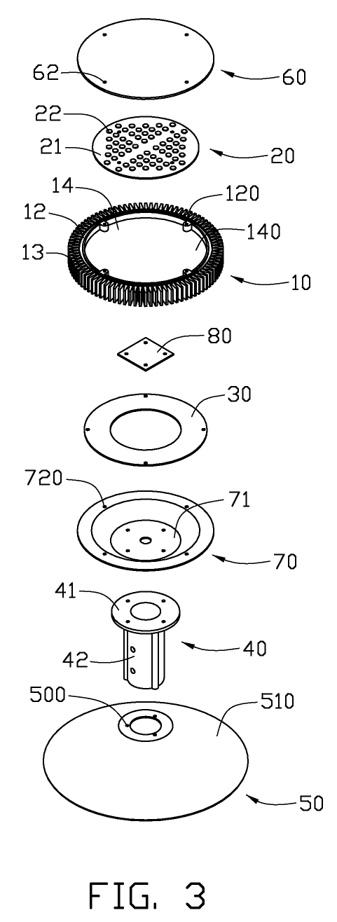

Also referring to FIG. 3, the heat sink 10 is substantially columned. The heat sink 10 comprises a columned base 12 and a plurality of fins 13 extending radially from a circumferential surface of the base 12. Each of the fins 13 has a plate shape and is parallel to a central axis of the base 12. A bottom end of the base 12 defines a round bottom recess 14 therein so as to form a ceiling 140. A top end of the base 12 defines a t op recess 15 therein. The ceiling 140 separates the bottom recess 14 and the top recess 15 as two isolated parts. A plurality of securing tabs 120 are inwards formed in the bottom and top recesses 14, 15 and positioned at edges of the base 12. Each of the securing tabs 120 defines a hole (not shown) therein. Fasteners (not shown) are used to extend through the bottom and top envelopes 60, 70 to threadedly engage in the holes of the securing tabs 120 thereby securing the bottom and top envelopes 60, 70 to the base 12. A tubular holder 16 extends upwardly from a centre of the top end of the base 12 to make the top recess 15 annular, so that an annular mounting surface 150 is formed on the top end of the base 12. A chamber 160 is defined in the holder 16. The rectifier 80 is received in the chamber 160 of the holder 16 and electrically connected with the first and second LED modules 20, 30.

The first LED module 20 comprises a circular plate 21 and a plurality of LEDs 22 mounted on the plate 21. The first LED module 20 is mounted on the ceiling 140 of the bottom recess 14 at the bottom end of the base 12. The second LED module 30 comprises an annular plate 31 and a plurality of LEDs 32 mounted on the plate 31. The second LED module 30 surrounds the holder 16 and is mounted on the mounting surface 150 of the top recess 15 at the top end of the base 12.

The bottom and top envelopes 60, 70 each are made of transparent material such as glass. The envelope 70 comprises a top platform 71 sandwiched between the holder 16 and the supporting post 40, an annular flange 72 engaging with the securing tabs 120 of the base 12, and a main body 73 aslant interconnecting the platform 71 and the flange 72. The platform 71 is located above the flange 72 and has a smaller diameter than the flange 72, whereby the main body 73 cooperates with the platform 71 to form a truncated cone configuration protruding upwardly from the flange 72. A plurality of securing holes 720 are defined in the flange 72 and surrounding the main body 73. The securing holes 720 are corresponding to the holes of the securing tabs 120 for the fasteners extending therethrough, thereby securing the top envelope 70 to the top end of the base 12. The top envelope 70 covers and protects the second LED module 30 and allows light generated by the second LED module 30 to irradiate therethrough to an outside of the LED lamp.

The bottom envelope 60 is configured as circular and defines a plurality of securing holes 62 corresponding to the holes of the securing tabs 120. The bottom envelope 60 is secured to the bottom end of the base 12 by the fasteners (not shown). The bottom envelope 60 covers the first LED module 20 to prevent it from damage by foreign factors. Light generated by the first LED module 20 can irradiate out of the envelope 60.

The supporting post 40 comprises a circular substrate 41 and a tube 42 extending upwardly from a centre of the substrate 41. The substrate 41 is located on the platform 71 of the top envelope 70 and connects to the holder 16 of the heat sink 10. In the present embodiment, the substrate 41, the platform 71 of the top envelope 70 and the holder 16 are engaged together by fasteners (not shown). A plurality of linear ribs 43 are evenly formed on an outer surface of the tube 42 to increase strength of the tube 42. The ribs 43 extend along an axial direction of the tube 42 and connect with the substrate 41. A plurality of securing holes 430 are defined in top ends of the ribs 43 of the tube 42.

The reflector 50 has a generally inverted conical shape, with a bottom thereof connecting the top end of the tube 42, and a top thereof facing away from the tube 42. The top of the reflector 50 has a larger size than the bottom thereof. A plurality of through holes 500 are defined in the bottom of the reflector 50 corresponding to the securing holes 430 of the supporting post 40, thereby allowing fasteners (not shown) to extend therethrough and to engage in the securing holes 430. Therefore, the reflector 50 is fixed on the supporting post 40, with a smooth reflecting surface 510 at a bottom, outer side thereof facing towards and slantwise to the second LED module 30. The reflector 50 is configured to reflect the light generated by the second LED module 30 downwardly.

In the present embodiment, the reflector 50 has a larger size than the second LED module 30, whereby a large amount of the light generated by the second LED module 30 can be reflected downwardly. It is to be understood that the shape and size of the reflector 50 and a gradient of the reflecting surface 510 of the reflector 50 could potentially be varied, so long as the light generated by the second LED module 30 can be reflected downwardly, thereby increasing an illumination area of an underside of the LED lamp.

Referring to FIG. 1 again, when the LED lamp is in use, the light generated by the first LED module 20 can directly irradiate through the bottom envelope 60 to the underside of the LED lamp. The light generated by the second LED module 30 is reflected by the reflector 50 towards the underside of the LED lamp. It is understood that by the reflecting surface 510 of the reflector 50 which has a slop, the light emitted from the planar second LED module 30 can be reflected in a multidirectional manner, which increases the illumination area of the underside of the LED lamp. A space of the LED lamp is well exploited due to the two LED modules 20, 30 being assembled at bottom and top ends of the heat sink 10, and heat generated by the two LED modules 20, 30 can be dissipated immediately by the heat sink 10. By the setting of the two LED modules 20, 30 and the reflector 50, the illumination brightness and area at the underside of the LED lamp are increased.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED lamp comprising:
a heat sink having a bottom end and an opposite top end;
a first LED module mounted on the bottom end of the heat sink;
a second LED module mounted on the top end of the heat sink;
a supporting post disposed on the top end of the heat sink; and
a reflector arranged on the supporting post and having a reflecting surface at a bottom, outer side thereof, the reflecting surface facing and being slantwise to the second LED module.

2. The LED lamp as claimed in claim 1, wherein the heat sink comprises a columned base and a plurality of fins extending radially from a circumferential surface of the base.

3. The LED lamp as claimed in claim 2, wherein each of the fins has a plate shape and is parallel to an axis of the base.

4. The LED lamp as claimed in claim 2, wherein two recesses are defined at a bottom and a top of the base and a mounting surface is formed in each of the recesses, the two LED modules are received in the two recesses respectively, and mounted on the mounting surfaces.

5. The LED lamp as claimed in claim 4, wherein a holder extends upwardly from the mounting surface of the top of the base to connect with the supporting post, and the second LED module is arranged surrounding the holder.

6. The LED lamp as claimed in claim 5, wherein the holder is tubular, and the LED lamp further comprises a rectifier received in the holder.

7. The LED lamp as claimed in claim 1, further comprising two envelopes covering the first and second LED modules.

8. The LED lamp as claimed in claim 7, wherein one of the envelopes covering the second LED module protrudes a platform in a centre thereof, and the supporting post is fixed on the platform.

9. The LED lamp as claimed in claim 8, wherein the supporting post comprises a substrate fixed to the platform and a tube extending upwardly from the substrate, a plurality of ribs formed on an outer surface of the tube.

10. The LED lamp as claimed in claim 1, wherein the reflector has an inverted conical shape with a bottom thereof facing towards the second LED module.

11. An LED lamp comprising:
a heat sink comprising a base having a first end and a second end opposing to the first end, and a plurality of fins extending from the base and between the first and second ends thereof;
a first LED module mounted on the first end of the base, light generated therefrom irradiating to a predetermined direction;
a second LED module mounted on the second end of the base;
a reflector facing towards the second LED module to reflect light generated by the second LED module towards the predetermined direction over an enlarged area; and
a supporting post with one end thereof connecting the second end of the base and another end thereof connecting the reflector.

12. The LED lamp as claimed in claim 11, wherein two recesses are defined at the first and second ends of the base and a mounting surface is formed in each of the recesses, the first and second LED modules are received in the two recesses respectively, and mounted on the mounting surfaces.

13. The LED lamp as claimed in claim 12, further comprising two envelopes covering the first and second LED modules, the envelope covering the second LED module being disposed between the base and the supporting post.

14. The LED lamp as claimed in claim 13, wherein a holder extends from the second end of the base to connect with the supporting post, the mounting surface for the second LED module being annular around the holder.

15. The LED lamp as claimed in claim 14, wherein the envelope covering the second LED module forms a platform, the platform mounted on the holder, the supporting post mounted on the platform.
